(19) United States
(12) Patent Application Publication
(10) Pub. No.: US 2003/0053630 A1
(43) Pub. Date: Mar. 20, 2003

(54) Method and system for key usage control in an embedded security system

(75) Inventors: Scott Thomas Elliott, Raleigh, NC (US); James Patrick Hoff, Raleigh, NC (US); Christopher Scott Long, Chapel Hill, NC (US); David Rivera, Durham, NC (US); Andy Llovd Trotter, Raleigh, NC (US); James Peter Ward, Raleigh, NC (US)

Correspondence Address: International Business Machines Corporation, Personal and Printing Systems Group, Dept. 9CCA/Bldg. 002-2, P.O. Box 12195, Research Triangle Park, NC, 27709, US

(73) Assignee: International Business Machines Corporation, Armonk, NY

(21) Appl. No.: 09/957,415

(22) Filed: Sep. 20, 2001

(51) Int. Cl. H04K 1/00

(52) U.S. Cl. 380/277

(57) ABSTRACT

A method and system for control of key pair usage in a computer system is disclosed. The method and system comprise creating key pair material for utilization with an embedded security chip of the computer system. The key pair material includes tag data. The method and system further includes determining whether the key pair material is bound to the embedded security chip based on the tag data.

Through the present invention, more flexibility for control over which keys are bound to an embedded security system is achieved. These and other advantages of the aspects of the present invention will be more fully understood in conjunction with the following detailed description and accompanying drawings.

### FIELD OF THE INVENTION

The present invention relates to generally to security systems, and more particularly to key usage control in an embedded security system.

### BACKGROUND OF THE INVENTION

In Intranet, Extranet, Virtual Private Networks, e-mail, and e-commerce applications, communication connections may traverse backbones and routers, as well as machines at secured or non-secured sites. Security is of high importance for such environments to ensure the confidentiality of transactions and communications. In an effort to improve security for computer systems, embedded security solutions have been sought. For example, the Trusted Computing Platform Alliance (TCPA) is an industry group focused on developing new hardware and software specification that will enable technology companies to offer a more trusted and secure personal computer platform based on common standards.

In creating common standards, a current specification (1.0) of the TCPA is largely based on an embedded security chip developed to provide a cryptographic microprocessor that is embedded in the system board of a computer system, e.g., an IBM NetVista or Thinkpad computer system. FIG. 1 illustrates a block diagram of an embedded security chip 10 coupled to a main processor 12. The chip 10 communicates with the main processor 12 of the computer through a System Management Bus (SMB), a subset of the Phillips I2C interface, as is well appreciated by those skilled in the art. In general, cryptographic operations are routed through the embedded security chip 10 (by cryptographic middleware), and the routing enables applications using appropriate APIs to secure cryptographic operations through the built-in hardware to offer more security than with a software solution.

With the embedded security chip, both RSA and PKI (public key infrastructure) operations, such as encryption for privacy and digital signatures for authentication, are supported. A PKI is a system of security that uses public key cryptography to manage keys and digital certificates to enable users of an essentially non-secured public network, such as the Internet, to securely and privately exchange data, including money in transactions and communications. (RSA stands for Rivest, Shamir, and Adleman, the developers of the RSA PKI.) To manage key creation and storage with the embedded security chip 10 (EEPROM 12 stores RSA key pairs), a key hierarchy is employed to manage the encryption keys. A unique hardware key pair and platform key pair form the basis of the hierarchy. Each user can then have a user key pair protected with a PIN (personal identification number.) Private key operations, such as digital signing, take place within the embedded security chip and are bound to a specific user through the PIN.

A concern with the use of key pairs in an embedded system is the ability to have key usage control. Particularly, there exists a problem of balancing the use of platform verifying keys and the use of user verifying keys. Platform verifying keys normally are bound to a system as defined by a serial number of the system.

As previously mentioned, a current implementation of an embedded security chip employs a hierarchical key structure to manage keys. A brief discussion of this structure is provided for reference purposes. Each key ring structure level is referred to as a key pair because a pair of keys, private and public, are required to secure each level. Each level is secured through the level below it by encrypting that level's private key with the public key of the underlying level's key pair. Thus, for a four level structure, level 3's private key is encrypted with the public key of level 2, level 2's private key is encrypted with the public key of level 1, and level l's private key is encrypted with the public key of level 0. As originally defined, a Level 0 or base hardware key pair resides entirely on the embedded security chip. A user creates the base hardware private key through a software utility, e.g., security chip setup, that provides an administrator interface to the functions of the embedded security chip. The hardware key pair is unique to the system. Rights and ownership of the hardware private key are established through an administrator password.

Once the base hardware private key has been created, Level 1 or platform key pairs can be created by an administrator in the software utility. The platform key pair is bound to the system as defined by the serial number of the system and does not change with changes to the key information below it. Upon creation, the platform private key pair is installed in the system key hierarchy by encrypting it with the base hardware public key. A virtual certificate for the platform key pair is also created during initialization. The platform public key is signed through the hardware private key using the administrator password.

Level 2 or user key pairs are associated with a specific user as defined by the operating system logon password. Upon creation, the private user key is encrypted with the public key of the platform key pair. Level 3 or credential key pairs are specific to a user and a specific application. During an application key-generation event, the private key associated with the credential is encrypted with the public key of the user as specified by the operating system logon password. The encrypted credential keys are bound to this user key pair, and only the authorized user can use those credential keys.

With the structure of the key hierarchy, the user verifying keys find a basis from the platform verifying keys and therefore also are bound to the system. Thus, in current implementations of an embedded security system, only if binding has been established between the system and the embedded security element can any RSA key be utilized. There are many environments where only the user need be verified rather than ensuring that the machine is bound to the platform. Accordingly, there is a need to allow for more flexibility in the use of RSA keys. The present invention addresses such a need.

### SUMMARY OF THE INVENTION

A method and system for control of key pair usage in a computer system is disclosed. The method and system comprise creating key pair material for utilization with an embedded security chip of the computer system. The key pair material includes tag data. The method and system further includes determining whether the key pair material is bound to the embedded security chip based on the tag data.

Through the present invention, more flexibility for control over which keys are bound to an embedded security system is achieved. These and other advantages of the aspects of the present invention will be more fully understood in conjunction with the following detailed description and accompanying drawings.

### BRIEF DESCRIPTION OF THE DRAWINGS

FIG. 1 illustrates a block diagram of a computer system board including an embedded security chip.

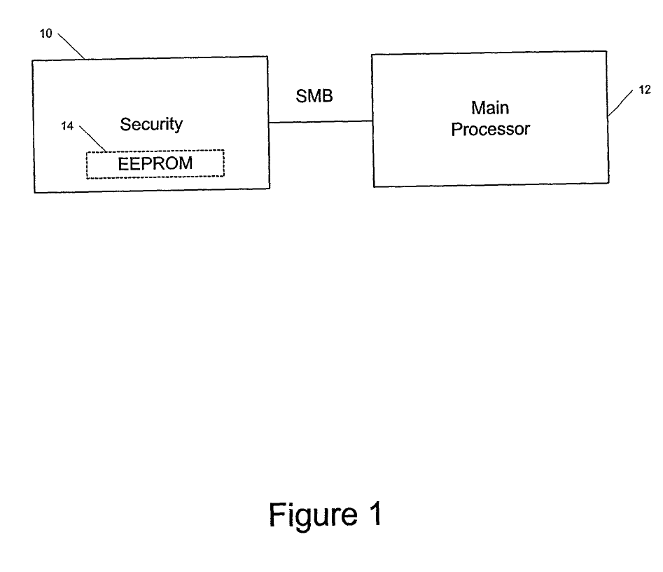

FIG. 2A illustrates a data structure 100 for allowing for managing the binding of the key pair to the security chip.

FIG. 2B illustrates an example of a hierarchical key pair structure employing tag data to indicate binding in accordance with the present invention.

FIG. 3 illustrates a block flow diagram of a process for key usage control in accordance with the present invention.

### DETAILED DESCRIPTION

The present invention relates to key usage control in an embedded security system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In order to have a more flexible approach to the utilization of key pairs in an embedded security system, the present invention provides a tag with the key pair material. The tag is either set or not set to indicate whether a particular key pair should be bound to the system. In accordance with the present invention, for example, a platform level of key pairs remains bound to a system, while user levels of key pairs have more flexibility of use and are not bound to a system by the embedded security chip.

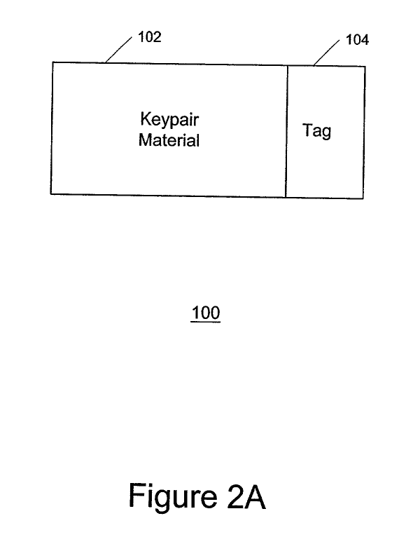

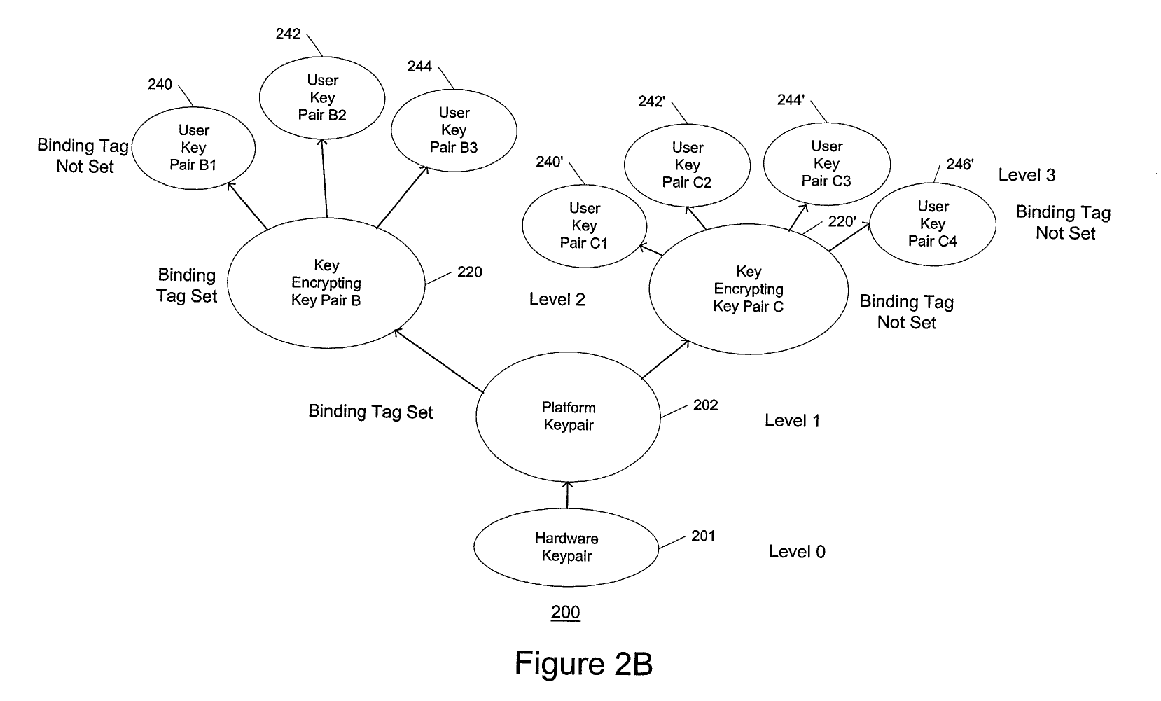

FIG. 2A illustrates a data structure 100 for allowing for managing the binding of the key pair to the security chip. As is seen, the data structure 100 includes key pair material 102 and an associated tag 104. In a preferred embodiment the tag 104 is one bit which can be set or not, dependent upon whether the key pair material 102 is to be bound to the security chip.

FIG. 2B illustrates an example of key hierarchy 200 where certain key pairs are binding-required and others are not binding-required. In this embodiment, there are four levels. Level 0 is hardware key pair 201. Level 1 is the platform key pair 202. Level 2 are a plurality of key encrypting key pairs 220 and 220′. Finally, level 3 are user key pairs 240-244 and 240′-246′. A level 1 key pair or platform key pair 202 has a tag associated with it, so as to indicate that binding must be established with the system before platform key operations are enabled. As a result, the platform is verified. For the level 2 and 3 key pairs 202, 202′, 240-244 and 240′-246′, however, the binding tag is not set for each level, to indicate that binding of these key pairs is not required to be established. As a result, the user keys 240-244 and 242′-246′are available to their verified owner regardless of the binding.

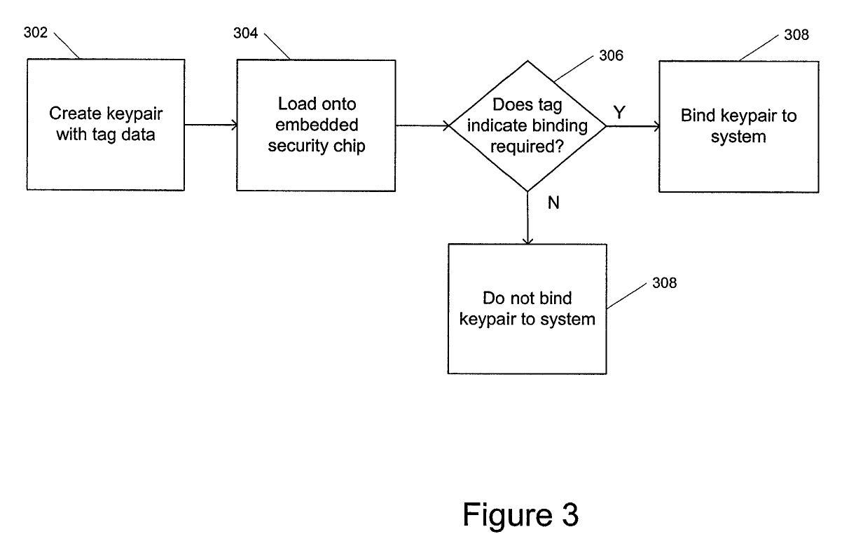

To describe the process of key usage control in more detail, refer now to the following discussion in conjunction with the accompanying Figure. A process for key usage control in accordance with a preferred embodiment of the present invention is illustrated in the flow diagram of FIG. 3. In this process, first key pair material including tag information is created for a particular level, via step 302. Preferably, the creation of the key pair material occurs in a standard manner for the embedded security chip with the exception that now tag information is included with the key pair material. The key pair tag information combination is then loaded material onto the embedded security system, via step 304. When the key pair material is loaded onto the embedded security system, the predefined process of loading includes a check for the status of the tag by the embedded security chip internally, via step 306. If the tag indicates that the key is a binding-required key, the embedded security chip only allows cryptographic functions to be performed using this key, via step 308. If the tag indicates that the key is not designated as a binding required key, the embedded security chip allows all operations on the embedded security chip with that key regardless of binding, under the assumption that the user is verified by their password, via step 310. By way of example, a single bit could be used to indicate a set/reset status, where a set status indicates that the key is a binding-required key and a reset status indicates that the key is not a binding-required key.

Accordingly, in a system and method in accordance with the present invention, the inclusion of tag data in the key material allows user keys to be designated as not binding-required, so that they may be verified securely on any system. Access to the embedded security subsystem remains secure, since the platform is verified only on the system where binding is established. In this manner, there is more selective allowance of key types based on binding.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for control of key pair usage in a computer system, the method comprising:
(a) creating key pair material for utilization with an embedded security chip of the computer system, the key pair material including tag data; and
(b) determining whether the key pair material is bound to the embedded security chip based on the tag data.

2. The method of claim 1 wherein the tag data further comprises a bit to indicate whether binding is required for the key pair material.

3. The method of claim 1 wherein creating key pair material further comprises creating key pair material of different levels.

4. The method of claim 3 wherein the different levels further comprise four levels.

5. The method of claim 4 wherein the four levels further comprise a hardware key pair level, a platform key pair level, a user key pair level, and a credential key pair level.

6. The method of claim 5 wherein including tag data further comprises including a tag for indicating binding is required for the platform key pair level.

7. A computer system with control over key pair usage, the computer system comprising:
a main processor for controlling the computer system; and
a security processor coupled to the main processor for embedded security in the computer system, the security processor for storing tag data with key pair material and determining binding of the key pair material to the security processor based on the tag data.

8. The system of claim 7 further comprising means for security setup to provide an interface on the computer system for administration of the security processor, including providing the tag data.

9. The system of claim 8 wherein the tag data comprises a bit to indicate whether binding is required for the key pair material.

10. The system of claim 7 wherein the security processor includes memory for storing the key pair material.

11. The system of claim 7 wherein the security processor manages the key pair material in a hierarchical structure.

12. The system of claim 11 wherein the hierarchical structure further comprises a four level structure.

13. The system of claim 12 wherein the four level structure further comprise a hardware key pair level, a platform key pair level, a user key pair level, and a credential key pair level.

14. The system of claim 13 wherein the key pair material further comprises a tag to indicate binding is required for the platform key pair level.

15. The system of claim 14 wherein the key pair material further comprises a tag to indicate binding is not required for the user key pair level.

16. A method for controlling usage of key pairs in a hierarchical structure of key pairs in an embedded security chip, the method comprising:
storing tag data with key pair data for each level of the hierarchical structure; and
determining whether the key pair data is bound to the embedded security chip based on the tag data.

17. The method of claim 16 wherein storing tag data further comprises storing a set tag bit to indicate that binding is required and storing a reset tag bit to indicate that no binding is required.

18. The method of claim 17 further comprising utilizing the reset tag bit with a user key pair level in the hierarchical structure to allow user key pairs to be verified securely on more than one computer system.

19. The method of claim 18 further comprising utilizing the set tag bit with a platform key pair level in the hierarchical structure to allow a platform key pair to be verified only on a computer system where binding with the embedded security chip is established.
